(19) United States
(12) Patent Application Publication
(10) Pub. No.: US 2019/0144298 A1
(43) Pub. Date: May 16, 2019

(54) HIGH-STRENGTH INTEGRATED WATER CHANNEL PACK

(71) Applicants: XIAOPING CHEN, FOSHAN (CN); FOSHAN VIOMI ELECTRICAL TECHNOLOGY CO., LTD., FOSHAN (CN)

(72) Inventor: XIAOPING CHEN, FOSHAN (CN)

(21) Appl. No.: 16/098,501

(22) PCT Filed: Mar. 13, 2017
(86) PCT No.: PCT/CN2017/076449

§ 371 Date: Nov. 2, 2018

(30) Foreign Application Priority Data
May 3, 2016 (CN) 201610283099.X

(51) Int. Cl. C02F 1/00; C02F 1/28; C02F 1/44

(52) U.S. Cl. CPC C02F 1/003; C02F 1/283; C02F 1/441; C02F 2307/14; C02F 2201/005; C02F 2301/028; C02F 2301/08; C02F 2201/004

(57) ABSTRACT

A high-strength integrated water channel pack with a plurality of channels is composed of a water channel pack body and a cover plate, with both being injection molded of a mixture of polypropylene and glass fibers. The water channel pack body is provided with at least one filter element connecting port. All filter element connecting ports and the water channel pack body are integrally molded. The filter element connecting port is internally provided with at least one water inlet hole and at least one water outlet hole. The bottom surface of the water channel pack body and/or the top surface of the cover plate are each provided with a plurality of slots. The water channel pack body and cover plate are connected to each other and enclose the slots to form the channels. At least one water inlet hole and at least one water outlet hole are connected with the channels.

### BACKGROUND OF THE INVENTION

### Field of the Invention

The present invention relates to an integrated water channel module, particularly to a high strength integrated water channel pack, which is primarily applied to water purification devices.

### Description of the Related Art

In Sep. 30, 2015, a China patent No. 104944608A disclosed a water purification device, an integrated water channel module for the water purification device, and a method for fabricating the integrated water channel module. A plurality of water channels is formed inside the integrated water channel module. The integrated water channel module comprises at least one module body and at least one cover. The module body and/or the cover respectively have a plurality of slots. The module body and the cover are connected sealedly in an injection molding method. The module body and the cover are joined together to form a portion of the water channels. The prior art patent can replace various pipes and various connectors with an integral water channel module, whereby to terminate water leakage—the biggest problem caused by ineffective sealing of pipes and connectors. Further, the structures of water purification devices are greatly simplified. The integrated water channel module has a plurality of interfaces. The interface can be joined with a filter port in an insertion way, and the filter elements are disposed in the filter ports to form a water purification device. In the prior art, the filter ports and the integrated water channel module are separated parts, and the connection thereof is also likely to suffer from water leakage. The interfaces of the integrated water channel module and the filter ports are located in the perimeter. The filter elements are components weighing heavily. Hence, the filter ports function like cantilevers sustaining heavy objects. Thus, water leakage is likely to appear in the joint between the integrated water channel module and the filter ports. Besides, the filter elements are irregularly distributed in the periphery of the integrated water channel module. Further, different filter elements have different weights. Thus, the center of gravity of the water purification device is offset from the center of geometry, which would induce imbalance of the device. Furthermore, the product of the prior art has a larger volume and a higher cost. The water channels of the integrated water channel module are not on the same plane. Therefore, the integrated water channel module is formed by joining at least three parts together in a two-shot injection molding technology or in a 3D printing technology. Thus, the prior art has a higher fabrication difficulty and a lower fabrication efficiency. Moreover, as the prior-art integrated channel module is made of plastic materials, it has lower rigidity and strength and is likely to be damaged.

### SUMMARY OF THE INVENTION

The primary objective of the present invention is to overcome the deficiencies of the existing technologies and provide a high strength water channel pack, which has a simple, tough, lightweight and rational structure.

In order to achieve the abovementioned objective, the present invention proposes a high strength integrated water channel pack, which comprises an integrated water channel pack. A plurality of channels is arranged in the integrated water channel pack. The integrated water channel pack is characterized in comprising a water channel pack body and a cover plate. The water channel pack body and the cover plate are fabricated with a mixture of polypropylene and glass fibers in an injection molding technology. The water channel pack body is provided with at least one filter element connecting port, and all the filter element connecting ports and the water channel pack body are integrally molded. The filter element connecting port is internally provided with at least one water inlet hole and at least one water outlet hole. The bottom surface of the water channel pack body and/or the top surface of the cover plate are each provided with a plurality of slots. The water channel pack body and the cover plate are connected to each other and enclose the slots to form the channels. The at least one water inlet hole and the at least one water outlet hole interconnect with the channels.

The objectives of the present invention may be further realized by the technical measures involved in the embodiments described below.

In one embodiment, the water channel pack body is provided with at least two the filter element connecting ports, and the filter element connecting ports are linearly arranged on a top side of the water channel pack body, whereby the filter elements can be disassembled easily.

In one embodiment, enclosing sidewalls are formed in perimeters of the slots of the water channel pack body and/or the cover plate; connection ridges are formed on outer rims of the enclosing sidewalls; the connection ridges are fused to solder together the water channel pack body and the cover plate.

In one embodiment, a width of the connection ridge is smaller than a width of the enclosing sidewall. While the water channel pack body and the cover plate are being joined together, the connection ridges are melted. Residue spaces are formed between the enclosing sidewalls and the lateral sides of the connection ridges. The melted material of the connection ridges does not flow to the enclosing sidewalls but flows to the residue spaces beforehand until the spaces have been completely filled up. Thus, only a small portion of melted material flows to the enclosing sidewalls. Thus, the flowrate of the channels is not affected obviously.

In one embodiment, the enclosing sidewall along the border is in form of a closed ring, and the connection ridge on the outer rim of the closed-loop enclosing sidewall is also in form of a closed ring. As the connection ridge along the border is a closed ring, the risk of water leakage is reduced.

In one embodiment, the enclosing sidewalls of the water channel pack body and the cover plate, which are corresponding to the borders, have everted edges along perimeters thereof; the everted edges have overflow resin grooves. While the connection ridges of the water channel pack body and the cover plate are melted in soldering, the melted material of the connection ridges joins together the water channel pack body and the cover plate, wherein the everted edges of the water channel pack body and the cover plate tightly contact each other, and most of the melted material of the connection ridges flows into and fuses with the overflow resin grooves. A portion of the melted material of the connection ridges is enclosed inside the overflow resin grooves. The joint between the water channel pack body and the cover plate is smooth and exempted from secondary processing.

In one embodiment, the water channel pack body is provided with 3 to 6 filter element connecting ports; the filter element connecting ports are linearly arranged on the top side of the water channel pack body according to a sequence by which water flows into the filter element connecting ports; connection disc assemblies are disposed inside the filter element connecting ports for engaging the filter element connecting ports with filter elements. After the filter element is inserted into the filter element connecting port carrying the connection disc assembly, the connection of the water channels and security of the filter element can be realized via merely rotating the filter element. The arrangement of the filter element connecting ports according to the sequence by which water flows into the filter element connecting ports can effectively shorten the water flow path and reduce the difficulty and cost of assembling the product.

In one embodiment, the filter element connecting ports include a reverse osmosis membrane filter element connecting port. The reverse osmosis membrane filter element connecting port is disposed at or near the center of the integrated water channel pack. The reverse osmosis membrane filter element is a larger and heavier element as well as a core element among the filter elements of the water purification device. Therefore, arranging the reverse osmosis membrane filter element at or near the center of the integrated water channel pack can make the product stand more stably and generate less noise.

In one embodiment, the front and rear sides of the water channel pack body have several functional insertion holes. The functional insertion hole and the channel interconnect with each other and have an included angle therebetween. The functional insertion holes are primarily to receive sensors. Because an included angle exists between the functional insertion hole and the channel, the surface of a sensor forms a backwater side after the sensor has been extended into the channel. Water flows more slowly in the backwater side, and slow water flow is favorable for the sensor to undertake detection and acquire more accurate data.

In one embodiment, the functional insertion hole and the channel have an included angle of 90 degrees therebetween.

The present invention has the following advantages:

(1) The high strength integrated water channel pack of the present invention is primarily made of a mixture of polypropylene and glass fiber. Therefore, the integrated water channel pack is lightweight and has a high strength. Further, the bottom surface of the water channel pack body and/or the top surface of the cover plate respectively have a plurality of slots, and the slots can enhance the strength of the integrated water channel pack.
(2) In the high strength integrated water channel pack of the present invention, the filter element connecting ports are linearly or almost linearly arranged. For example, the filter element connecting ports are arranged along a slightly-curved line. Thereby is achieved a shorter flow path and reduced the loss in water channels. Further, the product has a more rational structure and a smaller volume. In the present invention, the integration of the filter element connecting ports and the integration water channel pack is not to mechanically connect the components but to realize the continuation of the material of the components. Therefore, the joints of mechanical connection are decreased, and the probability of water leakage is reduced. Thus, the product becomes safer and more reliable.
(3) In the high strength integrated water channel pack of the present invention, the filter element connecting ports are all disposed on the same side. Thereby, the filter elements can be installed more easily.

### BRIEF DESCRIPTION OF THE DRAWINGS

FIG. 1 is an exploded view schematically showing the structure of a high strength integrated water channel pack according to one embodiment of the present invention;

FIG. 2 is an exploded view taken from another viewing angle of the structure in FIG. 1;

FIG. 3 is a diagram schematically showing the structure of a high strength integrated water channel pack according to one embodiment of the present invention;

FIG. 4 is a sectional view taken along Line A-A in FIG. 3;

FIG. 5 is a sectional view taken along Line B-B in FIG. 3;

FIG. 6 is an enlarged view of Area C in FIG. 5;

FIG. 7 is a diagram schematically showing that the cover plate and the water channel pack body shown in FIG. 6 are soldered together;

FIG. 8 is a bottom view of the structure shown in FIG. 3;

FIG. 9 is a top view of the structure shown in FIG. 3;

FIG. 10 is a rear view of the structure shown in FIG. 3 with the cover plate being taken away;

FIG. 11 is an exploded view schematically showing the structure of a high strength integrated water channel pack and connection disc assemblies thereof according to one embodiment of the present invention; and

FIG. 12 is an exploded view taken from another viewing angle of the structure in FIG. 11.

### DETAILED DESCRIPTION OF THE INVENTION

Below, embodiments are described in detail in cooperation with the attached drawings to further demonstrate the present invention.

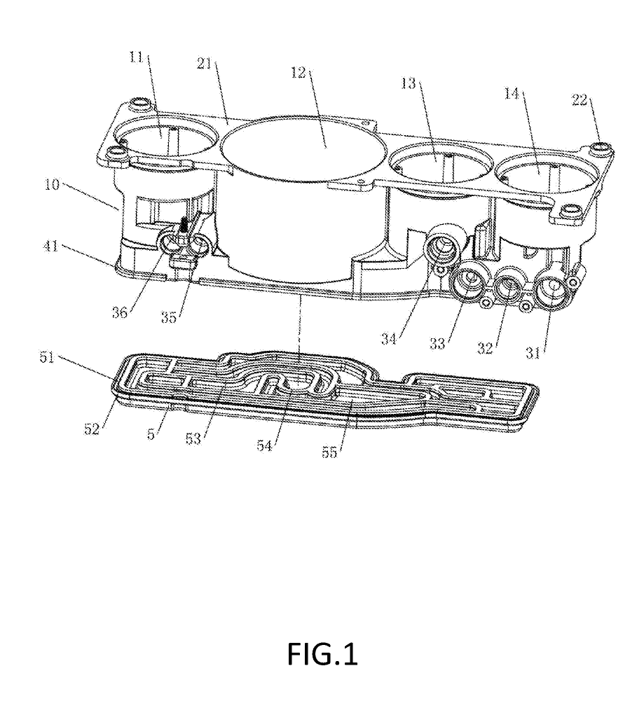

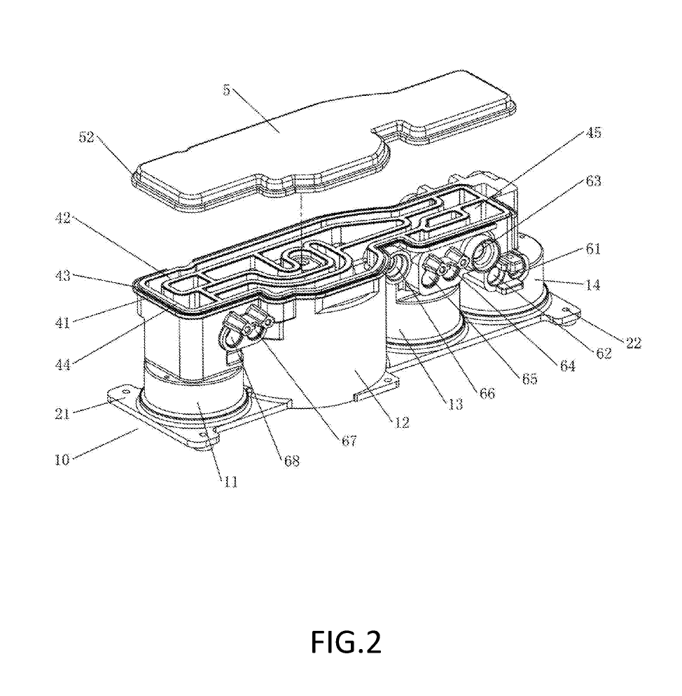

Refer to FIG. 1 and FIG. 2. The high strength integrated water channel pack of the present invention comprises an integrated water channel pack and at least two filter element connecting ports. A plurality of channels is arranged in the integrated water channel pack. All the filter element connecting ports and the integrated water channel pack are integrally molded. The filter element connecting port is internally provided with at least one water inlet hole and at least one water outlet hole. The at least one water inlet hole and the at least one water outlet hole interconnect with the channels. The filter element connecting ports are linearly arranged on the top side of the integrated water channel pack.

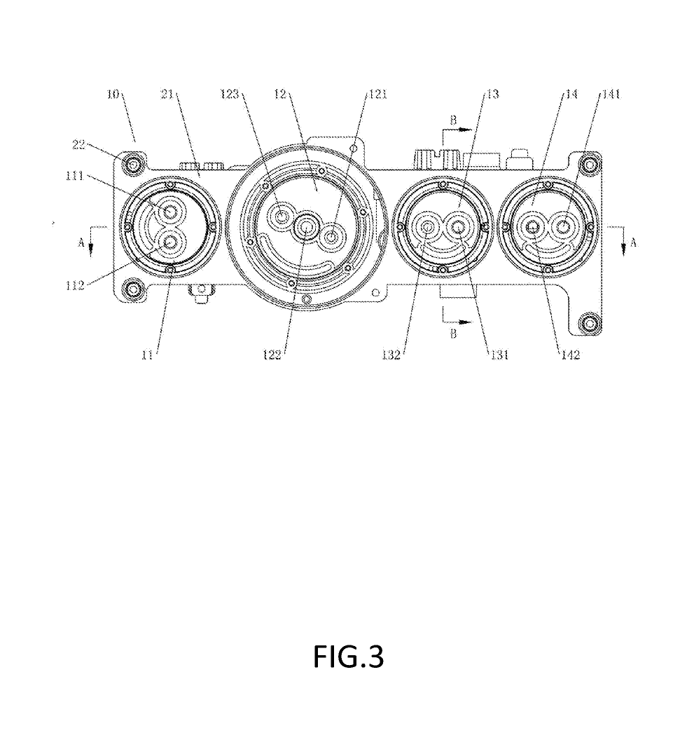

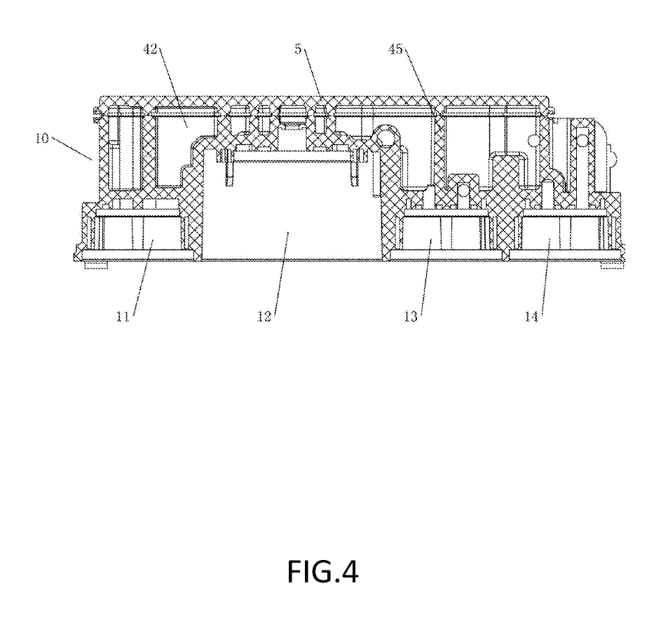

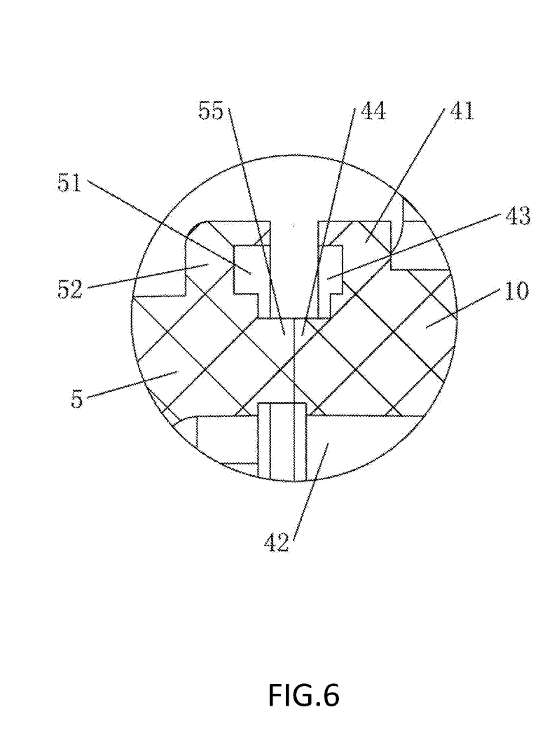

Also refer to FIGS. 3-6. There are four filter element connecting ports each in form of a basin, including a polypropylene (PP) cotton filter element connecting port 14, a front active charcoal filter element connecting port 13, a reverse osmosis membrane filter element connecting port 12, and a rear active charcoal filter element connecting port 11. The interior of the PP cotton filter element connecting port 14 has a first water outlet hole 141 and a first water inlet hole 142. The interior of the front active charcoal filter element connecting port 13 has a second water outlet hole 131 and a second water inlet hole 132. The interior of the reverse osmosis membrane filter element connecting port 12 has a third water outlet hole 123, a wastewater inlet hole 121, and a pure water inlet hole 122. The interior of the rear active charcoal filter element connecting port 11 has a fourth water outlet hole 111 and a fourth water inlet hole 112. The diameter of the reverse osmosis membrane filter element connecting port 12 is larger than the diameters of the other filter element connecting ports.

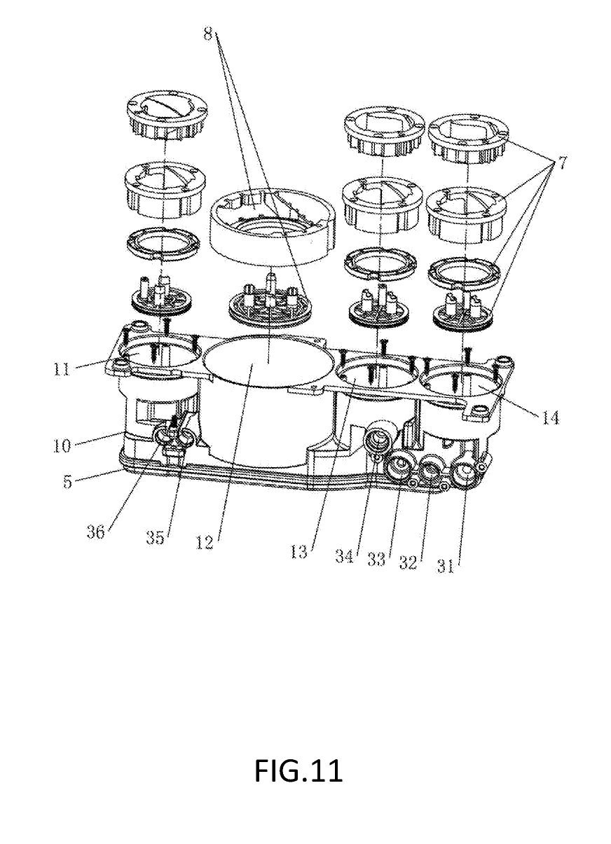

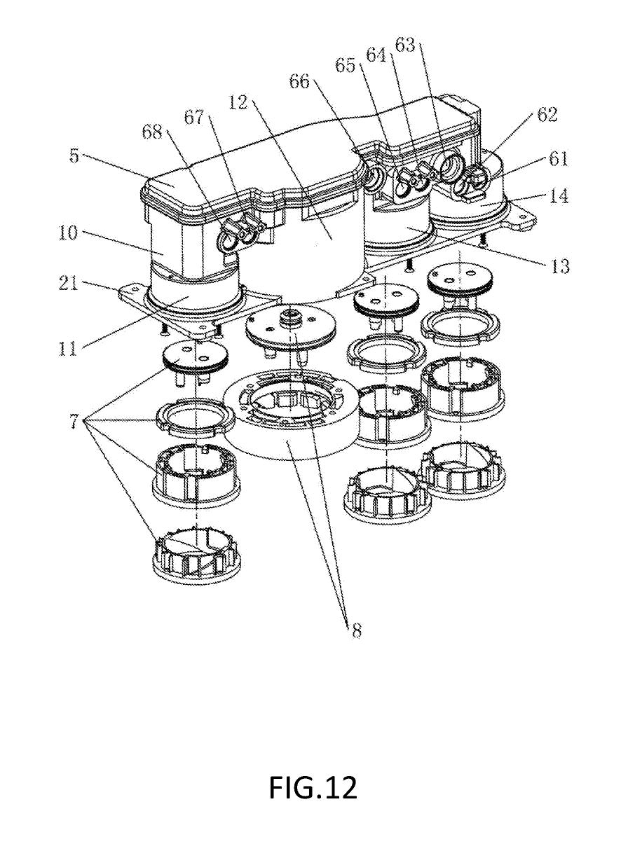

Refer to FIG. 11 and FIG. 12. The interior of the reverse osmosis membrane filter element connecting port 12 has a reverse osmosis membrane filter element connection disc assembly 8, which is used to assemble together the reverse osmosis membrane filter element and the reverse osmosis membrane filter element connecting port 12. The interiors of the PP cotton filter element connecting port 14, the front active charcoal filter element connecting port 13, and the rear active charcoal filter element connecting port 11 respectively have universal connection disc assemblies 7, which are respectively used to assemble the PP cotton filter element, the front active charcoal filter element, and the rear active charcoal filter element in the connecting ports thereof.

The reverse osmosis membrane filter element connecting port 12 is disposed at the center of the integrated water channel pack or near the center of the integrated water channel pack. The reverse osmosis membrane filter element is a larger and heavier element as well as a core element among the filter elements of a water purification device. Therefore, arranging the reverse osmosis membrane filter element at or near the center of the integrated water channel pack can make the product stand more stably and generate less noise.

The tops of the filter element connecting ports are leveled and connected by a support plate 21. The support plate 21 has connection holes 22.

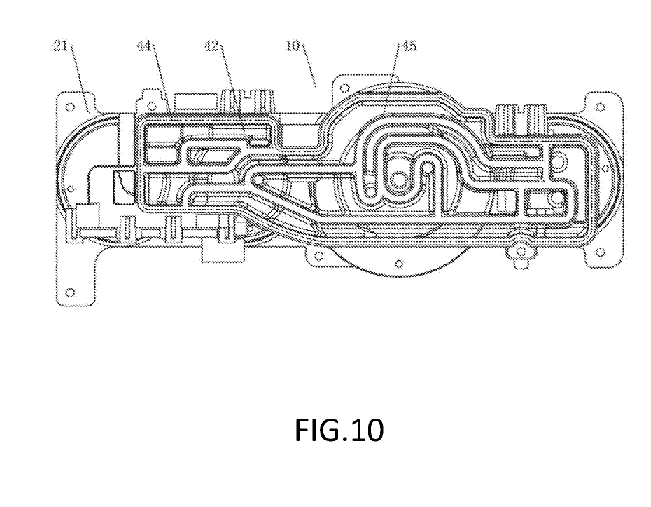

The integrated water channel pack comprises a water channel pack body 10 and a cover plate 5. The filter element connecting ports are at the top side of the water channel pack body 10. The bottom of the water channel pack body 10 and the cover plate 5 are soldered together. The bottom surface of the water channel pack body 10 and the top surface of the cover plate 5 respectively have a plurality of slots. After the water channel pack body 10 and the cover plate 5 are joined together, the slots are enclosed to form the channels. Enclosing sidewalls are formed in the perimeters of the slots of the water channel pack body 10 and the cover plate 5. Connection ridges are formed on the outer rims of the enclosing sidewalls. The enclosing sidewall along the border is in form of a closed ring. The connection ridge on the closed-loop enclosing sidewall is also in form of a closed ring. The width of the connection ridge is smaller than the width of the enclosing sidewall. Refer to FIG. 10 also. In detail, a plurality of upper slot bodies 42 is vertically formed on the bottom of the water channel pack body 10; upper enclosing sidewalls 45 are formed between the upper slot bodies 42; upper connection ridges 44 are formed on the outer rims of the upper enclosing sidewalls 45. The upper enclosing sidewall 45 along the border is in form of a closed ring. The upper connection ridge 44 on the closed-loop upper enclosing sidewall 45 is also in form of a closed ring. A plurality of lower slot bodies 55 is formed on the top of the cover plate 5 and opposite to the upper slot bodies 42 of the water channel pack body 10; lower enclosing sidewalls 53 are formed between the lower slot bodies 55; lower connection ridges 54 are formed on the outer rims of the lower enclosing sidewalls 53. The lower enclosing sidewall 53 along the border is in form of a closed ring. The lower connection ridge 54 on the closed-loop lower enclosing sidewall 53 is also in form of a closed ring.

The upper slot bodies 42 and the lower slot bodies 55 are respectively vertical to the water channel pack body 10 and the cover plate 5. The filter element connecting ports and the upper slot bodies 42 are respectively in the upper side and the lower side of the water channel pack body 10. Therefore, the water channel pack body 10 and the cover plate 5 may be fabricated in a simplest way, i.e. in upper and lower split molds. If the water channel pack body 10 has insertion holes in the lateral sides thereof, side cores may be added to the upper and lower molds to fabricate the insertion holes. Therefore, the present invention can be fabricated in a simpler way and a lower cost. Further, the integrated water channel pack is made of a mixture of polypropylene and glass fiber. Therefore, the integrated water channel pack of the present invention is lightweight and has high strength.

The enclosing sidewalls of the water channel pack body 10 and the cover plate 5, which are corresponding to the borders, have everted edges along the perimeters thereof. The everted edges have overflow resin grooves. While the connection ridges of the water channel pack body 10 and the cover plate 5 are melted in soldering, the melted connection ridges join together the water channel pack body 10 and the cover plate 5. In such a case, the everted edges of the water channel pack body 10 and the cover plate 5 tightly contact each other, and most material of the melted connection ridges is fused with the overflow resin grooves. In detail, the perimeter of the upper enclosing sidewall 45 of the water channel pack body 10, which is corresponding to the border, has a first everted edge 41, and the bottom of the first everted edge 41 has an upper overflow resin groove 43; the cover plate 5 has a second everted edge 52 corresponding to the first everted edge 41, and the second everted edge 52 has a lower overflow resin groove 51 corresponding to the upper overflow resin groove 43.

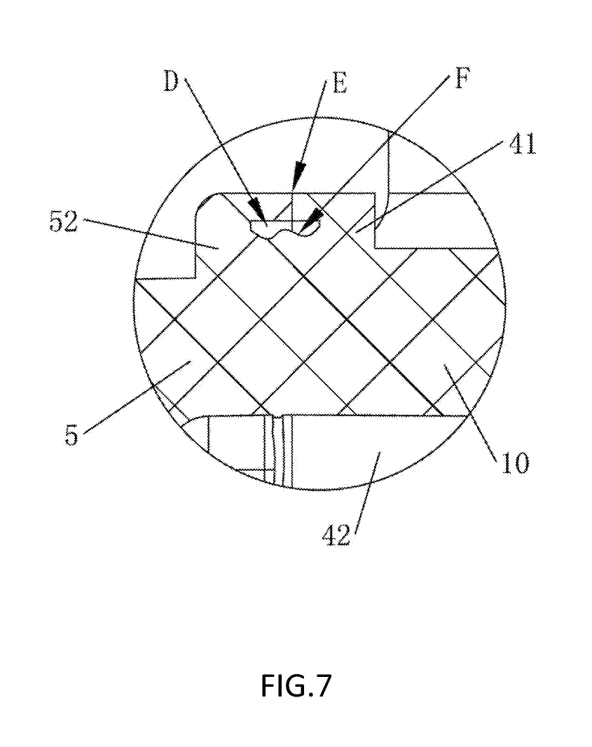

Refer to FIG. 7. While the water channel pack body 10 and the cover plate 5 are to be soldered together, the water channel pack body 10 and the cover plate 5 are compressed face to face, and the upper connection ridges 44 and lower connection ridges 54 are fused to join together, wherein a portion of the melted material of the upper connection ridges 44 and lower connection ridges 54 flows to the walls of the channels and wherein the melted material of the upper connection ridge 44 and the lower connection ridge 54, which are corresponding to the borders, mainly flows to the upper overflow resin groove 43 and the lower overflow resin groove 51 until the water channel pack body 10 and the cover plate 5 are completely pressed against each other and soldered together, as shown in FIG. 7 where the joint position (labeled by E) is smooth and exempted from secondary processing. At the same time, the upper overflow resin groove 43 and the lower overflow resin groove 51 enclose a space to form an overflow resin cavity D, and a portion of the melted material of the upper connection ridge 44 and the lower connection ridge 54 is enclosed inside the overflow resin cavity D and fused together with the wall of the overflow resin cavity D. The joint of the water channel pack body 10 and the cover plate 5 is maintained smooth. After the melted material solidifies, the water channel pack body 10 and the cover plate 5 are seamlessly connected to each other. Thus, the integrated water channel pack of the present invention has a high strength and is exempted from detachment and water leakage.

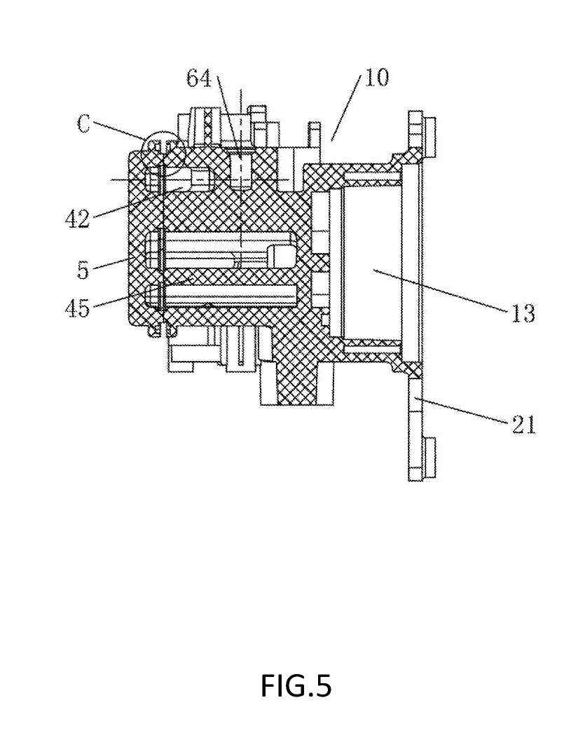

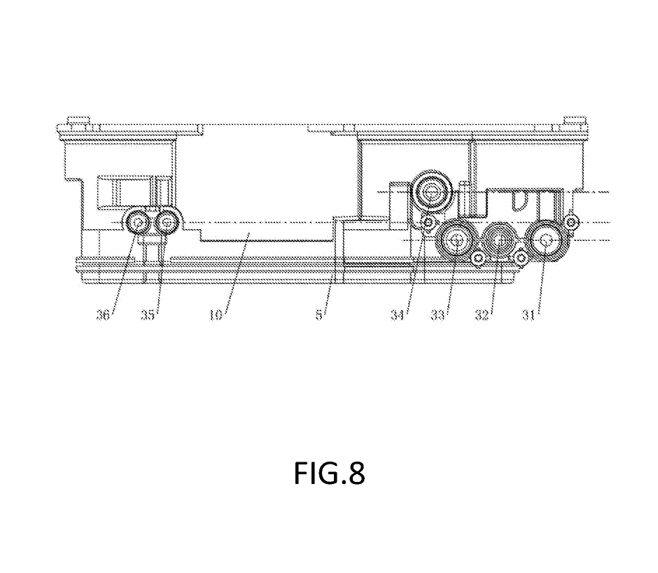

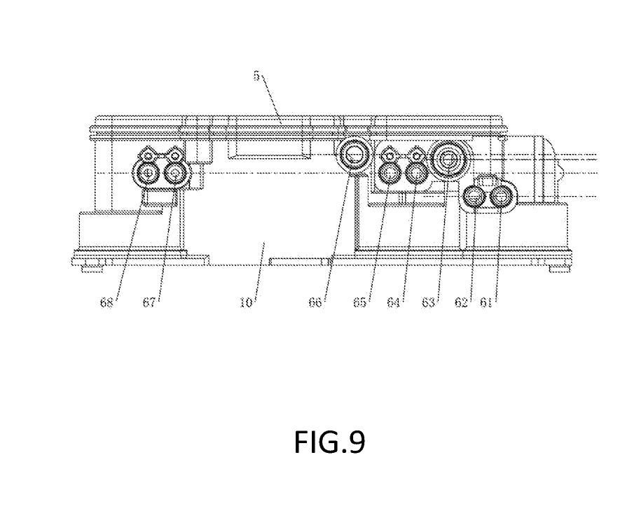

Refer to FIG. 8 and FIG. 9. In one embodiment, the integrated water channel pack is in form of a rectangle. The front and rear sides of the water channel pack body 10 have several functional insertion holes. The functional insertion hole and the channel have an included angle of 90 degrees therebetween, as shown by two center lines in FIG. 5. The water channel pack body 10 also includes a water inlet hole 31, a wastewater hole 32, and a purified water hole 33, which are disposed on the front side of the water channel pack body 10. In the embodiment shown in FIG. 8, the centers of the water inlet hole 31, the wastewater hole 32, and the purified water hole 33 are on an identical plane. The functional insertion holes include a first insertion hole 34, a second insertion hole 35, a third insertion hole 36, a fourth insertion hole 61, a fifth insertion hole 62, sixth insertion hole 63, a seventh insertion hole 64, an eighth insertion hole 65, a ninth insertion hole 66, a tenth insertion hole 67, and an eleventh insertion hole 68, wherein the first insertion hole 34, the second insertion hole 35, and the third insertion hole 36 are disposed on the front side of the water channel pack body 10, and wherein the fourth insertion hole to the eleventh insertion hole are disposed on the rear side of the water channel pack body 10. In the embodiment shown in FIG. 8, the center of the first insertion hole 34 is on a plane; the centers of the second insertion hole 35 and the third insertion hole 36 are on another plane; the centers of the water inlet hole 31, the wastewater hole 32, and the purified water hole 33 are on still another plane, as shown by the center lines in FIG. 8. In the embodiment shown in FIG. 9, the centers of the fourth insertion hole 61 and the fifth insertion hole 62 are on a plane; the center of the sixth insertion hole 63 is on another plane; the centers of the seventh insertion hole 64, the eighth insertion hole 65, the tenth insertion hole 67, and the eleventh insertion hole 68 are on still another plane; the center of the ninth insertion hole 66 is on yet another plane. Besides, the insertion holes on the front and rear sides may be on different planes.

Below is explained the operation of the integrated water channel pack of the present invention. Firstly, install the components of a water purification device in the integrated water channel pack; city water enters the integrated water channel pack from the water inlet hole 31, and then enters the PP cotton filter element via the first water outlet hole 141 of the PP cotton filter element connecting port 14, and then moves from the PP cotton filter element to the first water inlet hole 142, and then moves from the fourth insertion hole 61 through a flowmeter to the fifth insertion hole 62 and the eighth insertion hole 65; then the water flows through a flowrate electromagnetic valve to the seventh insertion hole 64; then the water flows through the sixth insertion hole 63 to a pump; then the water flows from the pump to the first insertion hole 34; then the water flows from the second water outlet hole 131 of the front active charcoal filter element connecting port 13 to the front active charcoal filter element; then the water flows from the second water inlet hole 132 of the front active charcoal filter element connecting port 13 through the third water outlet hole 123 of the reverse osmosis membrane filter element connecting port 12 to the reverse osmosis membrane filter element; then pure water generated by the reverse osmosis membrane filter element flows from the pure water inlet hole 122 of the reverse osmosis membrane filter element connecting port 12 through the second insertion hole 35 to a flowmeter; the pure water flows from the third insertion hole 36 through the fourth water outlet hole 111 of the rear active charcoal filter element connecting port 11 to the rear active charcoal filter element; then the pure water flows from the fourth water inlet hole 112 of the rear active charcoal filter element connecting port 11 to the purified water hole 33 and then flows out of the integrated water channel pack of the present invention. The wastewater generated by the reverse osmosis membrane filter element flows from the wastewater inlet hole 121 of the reverse osmosis membrane filter element connecting port 12 through the eleventh insertion hole 68, a flowrate regulation valve, and the tenth insertion hole 67 to the wastewater hole 32 and then flows out of the integrated water channel pack of the present invention.

1. A high strength integrated water channel pack, comprising an integrated water channel pack, wherein a plurality of channels is arranged in said integrated water channel pack, characterized in that said integrated water channel pack further comprises a water channel pack body (10) and a cover plate (5), and that said water channel pack body (10) and said cover plate (5) are fabricated with a mixture of polypropylene and glass fibers in an injection molding technology, and that said water channel pack body (10) is provided with at least one filter element connecting port, and that all said filter element connecting ports and said water channel pack body (10) are integrally molded, and that said filter element connecting port is internally provided with at least one water inlet hole and at least one water outlet hole, and that a bottom surface of said water channel pack body (10) and/or a top surface of said cover plate (5) are each provided with a plurality of slots, and that said water channel pack body (10) and said cover plate (5) are connected to each other and enclose said slots to form said channels, and that said water inlet hole and said water outlet hole interconnect with said channels.

2. The high strength integrated water channel pack according to claim 1, characterized in that said water channel pack body (10) is provided with at least two said filter element connecting ports, and that said filter element connecting ports are linearly arranged on a top side of said water channel pack body (10).

3. The high strength integrated water channel pack according to claim 1, characterized in that enclosing sidewalls are formed in perimeters of said slots of said water channel pack body (10) and/or said cover plate (5), and that connection ridges are formed on outer rims of said enclosing sidewalls, and that said connection ridges are fused to solder together said water channel pack body (10) and said cover plate (5).

4. The high strength integrated water channel pack according to claim 3, characterized in that a width of said connection ridge is smaller than a width of said enclosing sidewall.

5. The high strength integrated water channel pack according to claim 3, characterized in that said enclosing sidewall along a border is in form of a closed ring, and that said connection ridge on said outer rim of said enclosing sidewall in form of said closed ring is also in form of a closed ring.

6. The high strength integrated water channel pack according to claim 5, characterized in that said enclosing sidewalls of said water channel pack body (10) and said cover plate (5), which are corresponding to said borders, have everted edges along perimeters thereof, and that said everted edges have overflow resin grooves, and that while said connection ridges of said water channel pack body (10) and said cover plate (5) are melted in soldering, a melted material of said connection ridges joins together said water channel pack body (10) and said cover plate (5), and that said everted edges of said water channel pack body (10) and said cover plate (5) tightly contact each other, and that most of said melted material of said connection ridges flows into and fuses with said overflow resin grooves of said everted edges.

7. The high strength integrated water channel pack according to claim 1, characterized in that said water channel pack body (10) is provided with 3 to 6 said filter element connecting ports, and that said filter element connecting ports are linearly arranged on a top side of said water channel pack body (10) according to a sequence by which water flows into said filter element connecting ports, and that connection disc assemblies (7 and 8) are disposed inside said filter element connecting ports for engaging said filter element connecting ports with filter elements.

8. The high strength integrated water channel pack according to claim 7, characterized in that said filter element connecting ports include a reverse osmosis membrane filter element connecting port (12), and that said reverse osmosis membrane filter element connecting port (12) is disposed at or near a center of said integrated water channel pack.

9. The high strength integrated water channel pack according to claim 1, characterized in that front and rear sides of said water channel pack body (10) have several functional insertion holes, and that said functional insertion hole and said channel interconnect with each other and have an included angle therebetween.

10. The high strength integrated water channel pack according to claim 9, characterized in that said functional insertion hole and said channel have an included angle of 90 degrees therebetween.

11. The high strength integrated water channel pack according to claim 4, characterized in that said enclosing sidewall along a border is in form of a closed ring, and that said connection ridge on said outer rim of said enclosing sidewall in form of said closed ring is also in form of a closed ring.

12. The high strength integrated water channel pack according to claim 11, characterized in that said enclosing sidewalls of said water channel pack body (10) and said cover plate (5), which are corresponding to said borders, have everted edges along perimeters thereof, and that said everted edges have overflow resin grooves, and that while said connection ridges of said water channel pack body (10) and said cover plate (5) are melted in soldering, a melted material of said connection ridges joins together said water channel pack body (10) and said cover plate (5), and that said everted edges of said water channel pack body (10) and said cover plate (5) tightly contact each other, and that most of said melted material of said connection ridges flows into and fuses with said overflow resin grooves of said everted edges.
